(19) United States
(12) Patent Application Publication
(10) Pub. No.: US 2007/0206166 A1
(43) Pub. Date: Sep. 6, 2007

(54) Light-projecting system for a projector and method of projecting light thereof

(76) Inventor: Jing-Miau Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/365,622

(22) Filed: Mar. 2, 2006

(51) Int. Cl. G03B 21/20

(52) U.S. Cl. 353/102

(57) ABSTRACT

A light-projecting system includes a lamp module, a lens module and a uniform light module. The lamp module has a light source and a reflector for surrounding a part of the light source, wherein the light source is used to produce light signals, and the reflector is used to receive and reflect light signals. The lens module is arranged beside the lamp module for receiving light signals from the reflector and projecting light signals. The uniform light module is arranged beside the lens module for receiving light signals from the lens module and uniforming light signals. Moreover, because the lens module replaces the plane glass of the prior art and the lens module has a light filtering coating coated thereon, not only is the distance between the lamp module and the uniform light module shortened, but the light-projecting effect is also increased.

### BACKGROUND OF THE INVENTION

1. Field of the Invention

The present invention relates to a light-projecting system for a projector and a method of projecting light thereof, and particularly relates to a lens module arranged between a lamp module and a uniform light module for obtaining dual light-condensing effects and reducing the distance between the lamp module and the uniform light module.

2. Description of the Related Art

Recent developments in optical and projection display technology have led to digital projection devices with excellent resolution that can be used to display information in briefings, meetings, conferences or trainings. They have even become an important apparatus in home entertainment systems. Potential purchasers of these display devices tend to look for a lightweight digital projection apparatus with high image quality and brightness that is reasonably priced.

FIG. 1 shows a schematic view of a light-projecting system for a projector in accordance with the prior art. The light-projecting system includes a lamp module 1a, a plane glass 2a and a light pipe 3a. The plane glass 2a is arranged between the lamp module la and the light pipe 3a for filtering lights from light signals 100a that are projected from the lamp module 1a.

However, in order to raise the light-projecting effect of the projector, designers usually improve some optical paths between the light pipe 3a and an image-projecting panel (not shown). Alternatively, they demand the manufacturer of the light source shorten the distance between the lamp wicks (not shown) of the lamp module 1a.

### SUMMARY OF THE INVENTION

The present invention provides a light-projecting system for a projector and a method of projecting light thereof. The light-projecting system provides a lens module arranged between a lamp module and a uniform light module for obtaining dual light-condensing effects and reducing the distance between the lamp module and the uniform light module. In other words, the reflector of the lamp module and the lens module sequentially condense light signals for producing dual light-condensing effects and shortening the focusing ranges of light signals. Hence, the uniform light module can receive a greater quantity of light signals and is therefore able to increase the light-projecting effect of the projector. Moreover, because the lens module of the present invention replaces the plane glass of the prior art and the lens module has a light filtering coating coated thereon, not only is the distance between the lamp module and the uniform light module shortened, but the light-projecting effect is also increased.

The first aspect of the invention is a light-projecting system for a projector. The light-projecting system includes a lamp module, a lens module and a uniform light module. The lamp module has a light source and a reflector for surrounding a part of the light source, wherein the light source is used to produce light signals, and the reflector is used to receive and reflect light signals. The lens module is arranged beside the lamp module for receiving light signals from the reflector and projecting light signals. The uniform light module is arranged beside the lens module for receiving light signals from the lens module and uniforming light signals.

The second aspect of the invention is a light-projecting system for a projector. The light-projecting system includes a lamp module, a lens module and a uniform light module. The lamp module has a light source and a reflector for surrounding a part of the light source, wherein the light source is used to produce light signals, and the reflector is used to receive and reflect light signals. The lens module is arranged beside the lamp module for receiving light signals from the reflector and projecting filtered light signals, wherein the lens module has a light filtering coating coated thereon, and the lens module is arranged at a predetermined angle relative to an axial line for filtering ultraviolet and infrared of light signals. The uniform light module is arranged beside the lens module for receiving filtered light signals from the lens module and uniforming filtered light signals.

The third aspect of the invention is a method of projecting lights of a light-projecting system for a projector. The method includes: providing a lamp module having a light source and a reflector for surrounding a part of the light source; producing light signals via the light source; receiving light signals from the light source via the reflector; reflecting light signals via the reflector; receiving light signals from the reflector via a lens module arranged beside the lamp module; projecting light signals via the lens module; receiving light signals from the lens module via a uniform light module arranged beside the lens module; and uniforming light signals via the uniform light module.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a schematic view of a light-projecting system for a projector in accordance with the prior art;

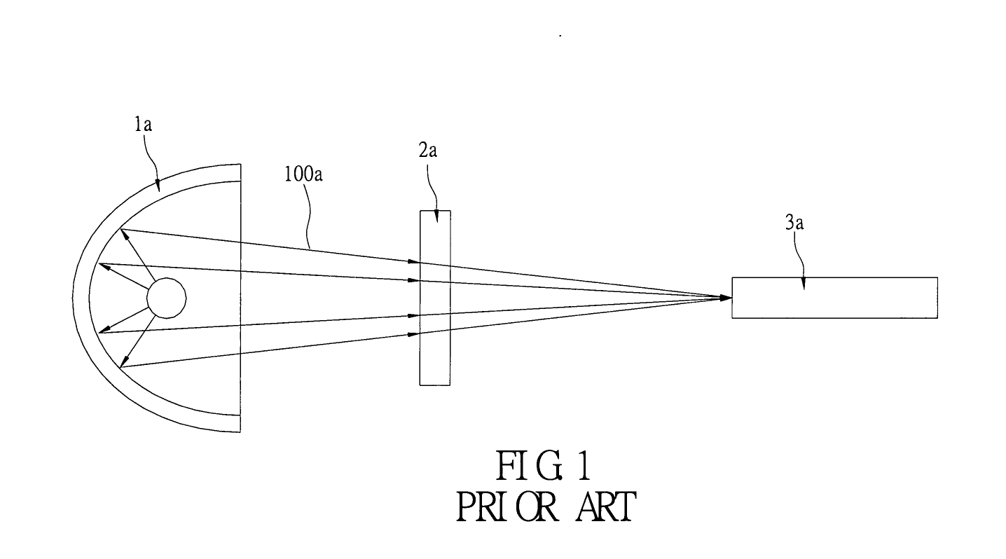

FIG. 2 is a schematic view of a light-projecting system for a projector in accordance with the first embodiment of the present invention;

FIG. 3 is a schematic view of a light-projecting system for a projector in accordance with the second embodiment of the present invention;

FIG. 4 is a flowchart of a method of projecting light from a light-projecting system for a projector in accordance with the first embodiment of the present invention; and

FIG. 5 is a flowchart of a method of projecting light from a light-projecting system for a projector in accordance with the second embodiment of the present invention.

### DETAILED DESCRIPTION OF PREFERRED EMBODIMENTS

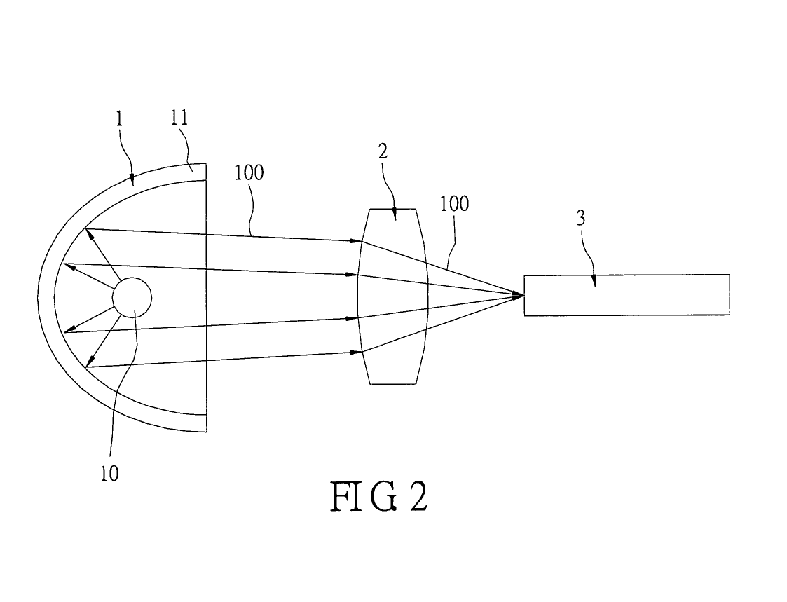

FIG. 2 shows a schematic view of a light-projecting system for a projector in accordance with the first embodiment of the present invention. The light-projecting system includes a lamp module 1, a lens module 2 and a uniform light module 3.

The lamp module 1 has a light source 10 and a reflector 11 for surrounding a part of the light source 10. The light source 10 is used to produce light signals 100, and the reflector 11 can be used to receive and reflect light signals 100. In addition, the lens module 2 is arranged beside the lamp module 1 for receiving light signals 100 from the reflector 11 and projecting light signals 100 out of the lens module 2.

Moreover, the lens module 2 can be a curve-shaped lens such as a dual convex lens that is used in the present invention. However, the dual convex lens does not limit the present invention, any curve-shaped lenses such as a single concave lens, a single convex lens, a dual concave lens or a concave-convex lens all can be adapted to the present invention.

Furthermore, the uniform light module 3 is arranged beside the lens module 2 for receiving light signals 100 from the lens module 2 and uniforming light signals 100, wherein the uniform light module 3 can be a light pipe.

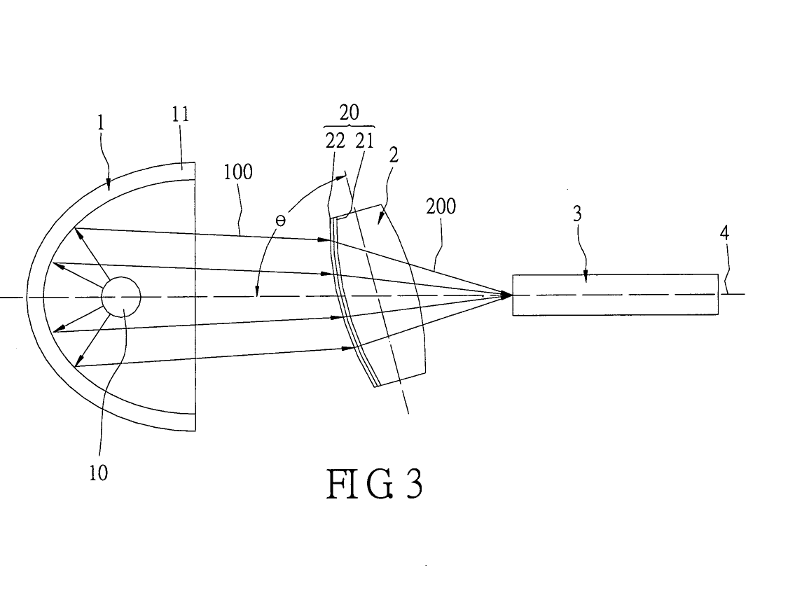

FIG. 3 shows a schematic view of a light-projecting system for a projector in accordance with the second embodiment of the present invention. The lens module 2 has a light filtering coating 20 coated thereon, and the light filtering coating 20 faces the lamp module 1 or faces the uniform light module 3. In addition, the lens module 2 is arranged at a predetermined angle θ relative to an axial line 4 for filtering lights from light signals 100, wherein the lights can be ultraviolet or infrared. Hence, the lens module 2 can be used to receive light signals 100 from the reflector and project filtered light signals 200, and the uniform light module 3 can be used to receive filtered light signals 200 from the lens module 2 and to uniform filtered light signals 200.

Moreover, in the present invention the light filtering coating 20 has an anti-ultraviolet coating 21 and an anti-infrared coating 22 sequentially formed on one surface thereof. However, the components of the above-mentioned light filtering coating 20 cannot be used to limit the present invention. Hence, the light filtering coating 20 can be an anti-infrared coating 22 and an anti-ultraviolet coating 21 sequentially formed on one surface thereof, or the light filtering coating 20 can be an anti-ultraviolet coating 21 and an anti-infrared coating 22 respectively formed on two surfaces thereof. In addition, users can choose whether the anti-ultraviolet coating 21 faces the lamp module 1 or whether the anti-infrared coating 22 faces the lamp module 1.

Furthermore, both the lens module 2 and the lamp module 1 are arranged on the same axial line 4, and the lens module 2 and the lamp module 1 are vertical to the axial line, respectively. Hence the lens module 2 and the lamp module 1 are parallel to each other. In other words, the lens module 2 can be arranged at a predetermined angle θ relative to the axial line 4 for filtering ultraviolet and infrared of light signals 100. For example, when the predetermined angle θ is adjusted to 90 degrees, the lens module 2 is vertical to the axial line 4.

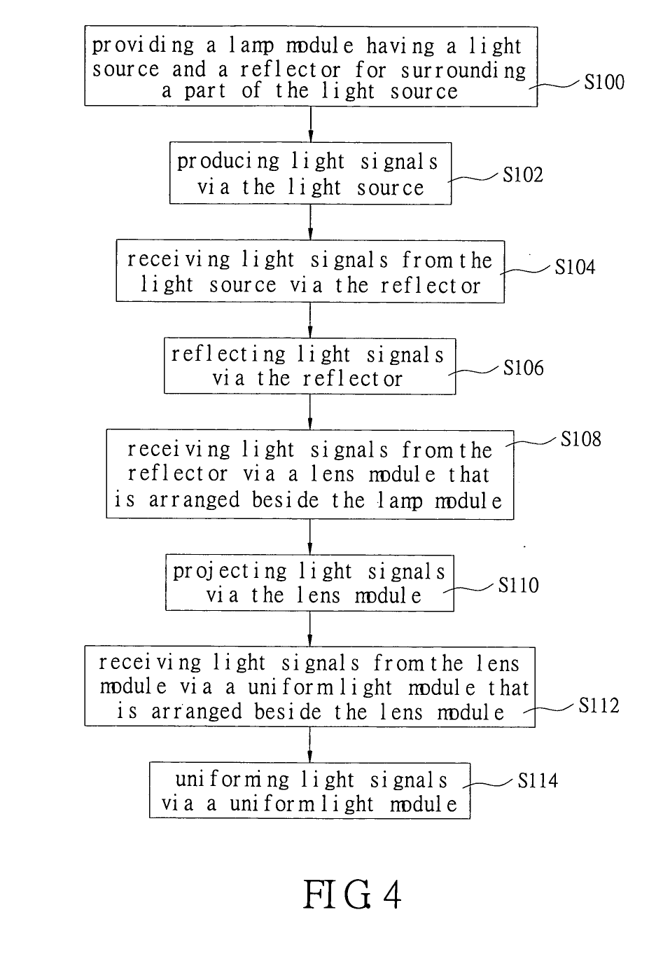

FIG. 4 shows a flowchart of a method of projecting light via a light-projecting system for a projector in accordance with the first embodiment of the present invention. The method includes: providing a lamp module 1 having a light source 10 and a reflector 11 for surrounding a part of the light source 10 (S100), producing light signals 100 via the light source 10 (S102), receiving light signals 100 from the light source 10 via the reflector 11 (S104), and reflecting light signals 100 via the reflector 11 (S106).

Moreover, the method includes receiving light signals 100 from the reflector 11 via a lens module 2 that is arranged beside the lamp module 1 (S 108). In addition, the lens module 2 is a curve-shaped lens, and the curve-shaped lens can be a single concave lens, a single convex lens, a dual concave lens, a dual convex lens or a concave-convex lens.

Furthermore, the light filtering coating 20 can be an anti-ultraviolet coating 21 and an anti-infrared coating 22 sequentially formed on one surface thereof, an anti-infrared coating 22 and an anti-ultraviolet coating 21 sequentially formed on one surface thereof, or an anti-ultraviolet coating 21 and an anti-infrared coating 22 respectively formed on two surfaces thereof. In addition, users can choose whether the anti-ultraviolet coating 21 faces the lamp module 1 or whether the anti-infrared coating 22 faces the lamp module 1.

Additionally, the lens module 2 has an axial line 4 the same as that of the lamp module 1. When the lens module 2 and the lamp module 1 are vertical respectively to the axial line 4, and the lens module 2 and the lamp module 1 are parallel to each other, or when the lens module 2 is arranged at a predetermined angle relative to the axial line 4, the lens module 2 can be used to filter ultraviolet and infrared of light signals 100.

The method further includes projecting light signals 100 via the lens module 2 (S110), receiving light signals 100 from the lens module 2 via a uniform light module 3 that is arranged beside the lens module 2 (S112), and uniforming light signals 100 via a uniform light module 3 (S114).

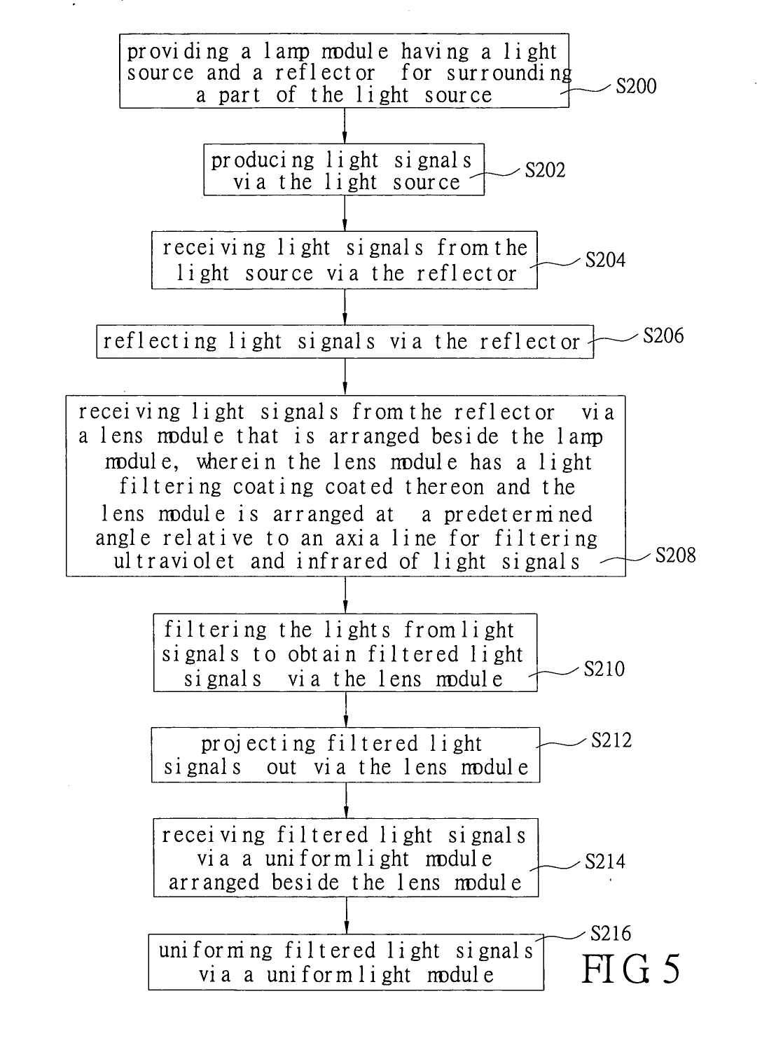

FIG. 5 shows a flowchart of a method of projecting lights of a light-projecting system for a projector in accordance with the second embodiment of the present invention. The method includes: providing a lamp module 1 having a light source 10 and a reflector 11 for surrounding a part of the light source 10 (S200), producing light signals 100 via the light source 10 (S202), receiving light signals 100 from the light source 10 via the reflector 11 (S204), and reflecting light signals 100 via the reflector 11 (S206).

Moreover, the method includes receiving light signals 100 from the reflector 11 via a lens module 2 that is arranged beside the lamp module 1, wherein the lens module 2 has a light filtering coating 20 coated thereon, and the lens module 2 is arranged at a predetermined angle relative to an axial line 4 for filtering ultraviolet and infrared of light signals 100 (S208). Afterward, the method includes filtering the lights from light signals 100 to obtain filtered light signals 200 via the lens module 2 (S210), projecting filtered light signals 200 out via the lens module 2 (S212), receiving filtered light signals 200 via a uniform light module 3 arranged beside the lens module 2 (S214), and uniforming filtered light signals 200 via a uniform light module 3 (S216).

In conclusion, the reflector 11 of the lamp module 1 and the lens module 2 condense sequentially light signals 100 for producing dual light-condensing effects and shortening the focusing ranges of light signals 100. Hence, the uniform light module 3 can receive a greater quantity of light signals 100 and can increase the light-projecting effect of the projector. Moreover, because the lens module 2 of the present invention replaces the plane glass 2a of the prior art and the lens module 2 has a light filtering coating 20 coated thereon, not only is the distance between the lamp module 1 and the uniform light module 3 shortened, but the light-projecting effect is also increased.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light-projecting system for a projector, comprising:
a lamp module having a light source and a reflector for surrounding a part of the light source, wherein the light source is used to produce light signals, and the reflector is used to receive and reflect light signals;
a lens module arranged beside the lamp module for receiving light signals from the reflector and projecting light signals; and
a uniform light module arranged beside the lens module for receiving light signals from the lens module and uniforming light signals.

2. The light-projecting system as claimed in claim 1, wherein the lens module is a curve-shaped lens.

3. The light-projecting system as claimed in claim 2, wherein the curve-shaped lens is a single concave lens, a single convex lens, a dual concave lens, a dual convex lens or a concave-convex lens.

4. The light-projecting system as claimed in claim 1, wherein the lens module has an anti-ultraviolet coating and an anti-infrared coating sequentially formed on one surface thereof.

5. The light-projecting system as claimed in claim 1, wherein the lens module has an anti-infrared coating and an anti-ultraviolet coating sequentially formed on one surface thereof.

6. The light-projecting system as claimed in claim 1, wherein the lens module has an anti-ultraviolet coating and an anti-infrared coating formed on two surfaces thereof, respectively.

7. The light-projecting system as claimed in claim 6, wherein the anti-ultraviolet coating faces the lamp module.

8. The light-projecting system as claimed in claim 6, wherein the anti-infrared coating faces the lamp module.

9. The light-projecting system as claimed in claim 1, wherein the lens module has an axial line the same as that of the lamp module.

10. The light-projecting system as claimed in claim 9, wherein the lens module and the lamp module are vertical respectively to the axial line, and the lens module and the lamp module are parallel to each other.

11. The light-projecting system as claimed in claim 9, wherein the lens module is arranged at a predetermined angle relative to the axial line for filtering ultraviolet and infrared of light signals.

12. The light-projecting system as claimed in claim 1, wherein the uniform light module is a light pipe.

13. A light-projecting system for a projector, comprising:
a lamp module having a light source and a reflector for surrounding a part of the light source, wherein the light source is used to produce light signals, and the reflector is used to receive and reflect light signals;
a lens module arranged beside the lamp module for receiving light signals from the reflector and projecting filtered light signals, wherein the lens module has a light filtering coating coated thereon, and the lens module is arranged at a predetermined angle relative to an axial line for filtering ultraviolet and infrared of light signals; and
a uniform light module arranged beside the lens module for receiving filtered light signals from the lens module and uniforming filtered light signals.

14. The light-projecting system as claimed in claim 13, wherein the lens module is a curve-shaped lens, and the curve-shaped lens is a single concave lens, a single convex lens, a dual concave lens, a dual convex lens or a concave-convex lens.

15. The light-projecting system as claimed in claim 13, wherein the light filtering coating has an anti-ultraviolet coating and an anti-infrared coating sequentially formed on one surface thereof, the light filtering coating has an anti-infrared coating and an anti-ultraviolet coating sequentially formed on one surface thereof, or the light filtering coating has an anti-ultraviolet coating and an anti-infrared coating respectively formed on two surfaces thereof, wherein the anti-ultraviolet coating faces the lamp module or the anti-infrared coating faces the lamp module.

16. The light-projecting system as claimed in claim 13, wherein the light filtering coating faces the lamp module or faces the uniform light module.

17. The light-projecting system as claimed in claim 13, wherein both the lens module and the lamp module are arranged on the same axial line, and the uniform light module is a light pipe.

18. A method of projecting lights of a light-projecting system for a projector, comprising:
providing a lamp module having a light source and a reflector for surrounding a part of the light source;
producing light signals via the light source;
receiving light signals from the light source via the reflector;
reflecting light signals via the reflector;
receiving light signals from the reflector via a lens module arranged beside the lamp module;
projecting light signals via the lens module;
receiving light signals from the lens module via a uniform light module arranged beside the lens module; and
uniforming light signals via a uniform light module.

19. The method as claimed in claim 18, wherein the lens module has an axial line the same as that of the lamp module, and the lens module is arranged at a predetermined angle relative to the axial line for filtering ultraviolet and infrared of light signals.

20. The method as claimed in claim 18, wherein the lens module has an anti-ultraviolet coating and an anti-infrared coating sequentially formed on one surface thereof, the lens module has an anti-infrared coating and an anti-ultraviolet coating sequentially formed on one surface thereof, or the lens module has an anti-ultraviolet coating and an anti-infrared coating formed on two surfaces thereof, respectively.
